(19) United States
(12) Patent Application Publication
(10) Pub. No.: US 2024/0355505 A1
(43) Pub. Date: Oct. 24, 2024

(54) WIRING SYSTEM AND MULTIPURPOSE WIRING MEMBER

(71) Applicant: Sumitomo Wiring Systems, Ltd., Mie (JP)

(72) Inventors: Masaki MIZUSHITA, Mie (JP); Yuya FUKAMI, Mie (JP); Kazuhiro NISHIMURA, Mie (JP); Hirozumi OKANIWA, Mie (JP); Motohiro YOKOI, Mie (JP)

(73) Assignee: Sumitomo Wiring Systems, Ltd., Mie (JP)

(21) Appl. No.: 18/685,664

(22) PCT Filed: Sep. 3, 2021
(86) PCT No.: PCT/JP2021/032473

§ 371 Date: Feb. 22, 2024

(51) Int. Cl. H01B 7/08; B60R 16/02

(52) U.S. Cl. CPC H01B 7/08; B60R 16/0207

(57) ABSTRACT

A wiring system is a wiring system including a multipurpose wiring member including at least one multipurpose circuit and a multipurpose connector to which the multipurpose circuit is connected, the wiring system further exclusively including: a first purpose wiring member including a first purpose circuit and a first purpose connector to which the first purpose circuit is connected, and a second purpose wiring member including a second purpose circuit and a second purpose connector to which the second purpose circuit is connected. When the first purpose connector is connected to the multipurpose connector, the multipurpose circuit is connected to the first purpose circuit, and when the second purpose connector is connected to the multipurpose connector, the multipurpose circuit is connected to the second purpose circuit.

### TECHNICAL FIELD

The present disclosure relates to a wiring system and a multipurpose wiring member.

### BACKGROUND ART

Patent Document 1 discloses a wire harness including: a first wiring member including a plurality of first wire-like transmission members and a first relay connector, some of the plurality of first wire-like transmission members being connected to the first relay connector; and a second wiring member including at least one second wire-like transmission member and a second relay connector to which the at least one second wire-like transmission member is connected.

### PRIOR ART DOCUMENTS

### Patent Document(S)

Patent Document 1: Japanese Unexamined Patent Application Publication (Translation of PCT Application) No. 2020-121463

### SUMMARY

### Problem to be Solved by the Invention

Various specifications may occur even in the same type of automobile depending on a difference in a mounted system or mounted apparatus, for example. It is desired to be able to easily deal with a plurality of specifications with a smaller number of circuits.

Accordingly, an object of the present disclosure is to be able to easily deal with a plurality of specifications with a smaller number of circuits.

### Means to Solve the Problem

A wiring system according to the present disclosure is a wiring system including a multipurpose wiring member including at least one multipurpose circuit and a multipurpose connector to which the multipurpose circuit is connected, the wiring system further exclusively including: a first purpose wiring member including a first purpose circuit and a first purpose connector to which the first purpose circuit is connected, the first purpose wiring member electrically connecting the first purpose circuit to a first electrical component; and a second purpose wiring member including a second purpose circuit and a second purpose connector to which the second purpose circuit is connected, the second purpose wiring member electrically connecting the second purpose circuit to a second electrical component of a type different from the first electrical component, wherein when the first purpose connector is connected to the multipurpose connector, the multipurpose circuit is connected to the first purpose circuit, and when the second purpose connector is connected to the multipurpose connector, the multipurpose circuit is connected to the second purpose circuit.

A multipurpose wiring member according to the present disclosure is a multipurpose wiring member including a multipurpose circuit connected to a different type of electrical component.

### Effects of the Invention

According to the present disclosure, it is possible to easily deal with a plurality of specifications with a smaller number of circuits.

### BRIEF DESCRIPTION OF DRAWINGS

FIG. 1 is an explanation view illustrating a wiring system in a vehicle.

FIG. 2 is an explanation view illustrating a specific example of the wiring system.

FIG. 3 is an explanation view illustrating an example of a wiring system dedicated to a first equipment specification.

FIG. 4 is an explanation view illustrating an example of a wiring system dedicated to a second equipment specification.

FIG. 5 is an explanation view illustrating an example of a connection destination part of a multipurpose circuit.

FIG. 6 is an explanation view illustrating a wiring system according to a modification example of an embodiment 1.

FIG. 7 is an explanation view illustrating a wiring system according to an embodiment 2.

### DESCRIPTION OF EMBODIMENT(S)

### Description of Embodiment of Present Disclosure

Embodiments of the present disclosure are listed and described firstly.

A wiring system according to the present disclosure is as follows.
(1) A wiring system includes a multipurpose wiring member including at least one multipurpose circuit and a multipurpose connector to which the multipurpose circuit is connected, the wiring system further exclusively including: a first purpose wiring member including a first purpose circuit and a first purpose connector to which the first purpose circuit is connected, the first purpose wiring member electrically connecting the first purpose circuit to a first electrical component; and a second purpose wiring member including a second purpose circuit and a second purpose connector to which the second purpose circuit is connected, the second purpose wiring member electrically connecting the second purpose circuit to a second electrical component of a type different from the first electrical component, wherein when the first purpose connector is connected to the multipurpose connector, the multipurpose circuit is connected to the first purpose circuit, and when the second purpose connector is connected to the multipurpose connector, the multipurpose circuit is connected to the second purpose circuit.

According to this wiring system, when the first purpose connector is connected to the multipurpose connector, the multipurpose circuit is used for connection to the first electrical component. When the second purpose connector is connected to the multipurpose connector, the multipurpose circuit is used for connection to the second electrical component. Thus, the multipurpose wiring member can be used for both a vehicle specification including the first electrical component and a vehicle specification including the second electrical component while using the multipurpose circuit for wiring to the first electrical component or the second electrical component. Accordingly, it is possible to easily deal with the plurality of specifications of vehicles while the number of the circuits is reduced.
(2) In the wiring system according to (1), the second purpose wiring member may be connected to the second electrical component exclusively mounted to the first electrical component in a vehicle. In this case, the first electrical component and the second electrical component are exclusively mounted to a vehicle. Thus, a circuit for the first electrical component and a circuit for the second electrical component need not be incorporated at the same time in the multipurpose wiring member. In this manner, the circuit of the first electrical component and the circuit for the second electrical component which need not be provided separately can be used as multipurpose circuits.
(3) In the wiring system according to (1) or (2), when a plurality of exclusive equipment systems in which a first equipment specification including the first electrical component and a second equipment specification including the second electrical component are exclusively adopted are set, the multipurpose circuit may include circuits exclusively connected to the first electrical component and the second electrical component to correspond to at least two of the plurality of exclusive equipment systems, respectively.

In this manner, when the plurality of exclusive equipment systems are provided, the multipurpose circuit can be used for the first equipment specification and the second equipment specification in common in at least two of the plurality of exclusive equipment systems. Accordingly, the multipurpose wiring member can deal with various combinations of the plurality of exclusive equipment systems.
(4) In the wiring system according to any one of (1) to (3), it is applicable that the multipurpose wiring member includes a plurality of circuits including at least one of the multipurpose circuits, and a ratio of a total number of the at least one of the multipurpose circuits to a total number of all of the plurality of circuits in the multipurpose wiring member is equal to or larger than 10%. Accordingly, the number of the circuits in the multipurpose wiring member can be effectively reduced. The number of all of the plurality of circuits in the multipurpose wiring member is the total number of the circuits included in the multipurpose wiring member regardless of a usage purpose of the circuits. For example, when the multipurpose wiring member includes a common circuit used as the same type of transmission path of electricity even in a case where any of the first purpose wiring member and the second purpose wiring member is selected, the number of all of the plurality of circuits in the multipurpose wiring member is the total number of the circuits including the common circuit.
(5) In the wiring system according to any one of (1) to (4), the multipurpose circuit may include a circuit transmitting a different type of electricity between a state where the first purpose connector is connected to the multipurpose connector and a state where the second purpose connector is connected to the multipurpose connector. Accordingly, the multipurpose circuit can be used as the circuit transmitting the different type of electricity.
(6) In the wiring system according to any one of (1) to (5), the multipurpose circuit may include a circuit transmitting a different type of electricity for any of a power source, a ground, and a signal between a state where the first purpose connector is connected to the multipurpose connector and a state where the second purpose connector is connected to the multipurpose connector. Accordingly, the multipurpose circuit can be used as the circuit transmitting the different type of electricity for any of the power source, the ground, and the signal.

A multipurpose wiring member according to the present disclosure is as follows.
(7) A multipurpose wiring member includes a multipurpose circuit connected to a different type of electrical component.

According to this multipurpose wiring member, the multipurpose circuit is used in common for a wiring of the different type of electrical component. Thus, separated circuit needs not be prepared for the different type of electrical component. The multipurpose wiring member is used for a specification of a vehicle including the different type of electrical component. Accordingly, it is possible to easily deal with the plurality of specifications of vehicles with a smaller number of circuits.

### DETAILED DESCRIPTION OF EMBODIMENT OF PRESENT DISCLOSURE

Specific examples of a wiring system and a multipurpose wiring member according to the present disclosure are described hereinafter with reference to the drawings. The present disclosure is not limited to these examples, but is indicated by claims, and it is intended that meanings equivalent to claims and all modifications within a scope of claims are included.

### Embodiment 1

A wiring system and a wiring member according to an embodiment 1 are described hereinafter.

### <Wiring System in Vehicle>

### <Example of System Equipped in Vehicle>

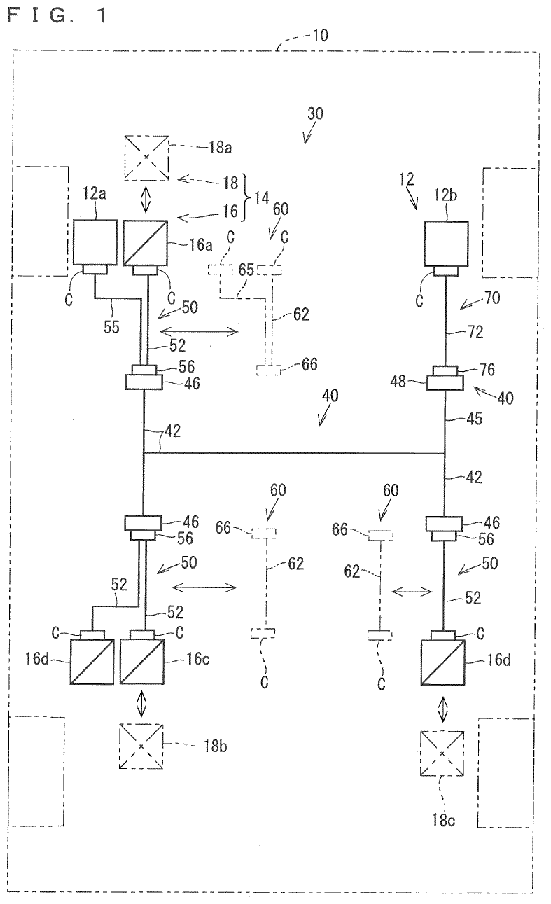

An example of a system mounted to a vehicle is described for convenience of description. FIG. 1 is a diagram illustrating a wiring system 30 in a vehicle 10. A common equipment system 12 is mounted to the vehicle 10. The common equipment system 12 is a system mounted to specific platform or a specific type of vehicle in common regardless of a difference of a grade and a difference of an optional component. For example, when a common instrument panel system is mounted to a specific platform or a specific type of vehicle, the instrument panel system is an example of the common equipment system 12. The common equipment system 12 includes at least one of electrical components 12a and 12b for achieving a function of the common equipment system 12. For example, when the common equipment system 12 is an instrument panel system, the common equipment system 12 includes a display device displaying various types of information for a driver, a switch receiving various instructions from the driver, and an electronic control unit (ECU) as the electrical components 12a and 12b. The ECU performs display control of the display device, reception of instruction via the switch, and reception of various signals from various types of sensors and the other ECU, for example. FIG. 1 exemplifies two electrical components 12a and 12b, however, the number and position thereof are not particularly limited.

An exclusive equipment system 14 is set to the vehicle 10. The exclusive equipment system 14 is a system capable of exclusively adopting a first equipment specification 16 and a second equipment specification 18 to the vehicle 10. Herein, an exclusive state indicates that when any one of a plurality of conditions is established, the other condition is not established. Thus, a state where the first equipment specification 16 and the second equipment specification 18 can be exclusively adopted indicates that when the first equipment specification 16 is adopted, the second equipment specification 18 cannot be adopted, and when the second equipment specification 18 is adopted, the first equipment specification 16 cannot be adopted. In this case, the exclusive equipment system 14 does not exclude a state where a third equipment specification and a fourth equipment specification, for example, can be adopted as the other exclusive choices in addition to the first equipment specification 16 and the second equipment specification 18.

An example of the exclusive equipment system is a case where the first equipment specification 16 is an automatic transmission (AT) specification, and the second equipment specification 18 is a manual transmission (MT) specification. For example, when the first equipment specification 16 is the AT specification, the exclusive equipment system includes a sensor detecting a position of a shift lever, a switch receiving instruction on an operation mode of AT, an AT mechanism including various solenoids and various sensors to change the number of rotations of a drive source, and an ECU for AT, as the electrical components 16a, 16b, 16c, and 16d. The ECU for AT controls a transmission gear ratio in the AT mechanism in accordance with a vehicle speed, the number of rotations of an engine, and an operation of an accelerator, for example. For example, when the second equipment specification 18 is the MT specification, the exclusive equipment system includes a sensor detecting a position of a shift lever, a sensor detecting a position of a clutch pedal, and an ECU for an engine, as the electrical components 18a, 18b, and 18c. The description according to the present embodiment is based on an assumption that the first equipment specification 16 is the AT specification, and the second equipment specification 18 is the MT specification. The AT specification and the MT specification are exclusively mounted to the vehicle 10 as specifications changing the rotation of the travel drive source and transmitting it to vehicle wheels.

FIG. 1 exemplifies two electrical components 12a and 12b, four electrical components 16a, 16b, 16c, and 16d, and two electrical components 18a, 18b, and 18c, however, the number and position thereof are optionally set.

The other example of the exclusive equipment system is a case where the first equipment specification is a mechanical key specification and the second equipment specification is a smart key specification. The mechanical key specification is a system that a key owned by a driver is inserted into a keyhole provided to a door or an area around a handle in a vehicle to lock and unlock the door, switch a state to a handle unlocked-state, and switch a state to an operable state of a power source, for example. The smart key specification is a system performing wireless communication between a wireless communication device mounted to a vehicle and a wireless key terminal owned by a driver to lock and unlock a door of the vehicle, switch a state to a handle unlocked-state, and switch a state to an operable state of a power source, for example. There is a possibility that the smart key specification includes a configuration relating to the mechanical key specification. A configuration relating to the smart key specification is not incorporated into the mechanical key specification. The mechanical key specification and the smart key specification are exclusively mounted to the vehicle as a security specification locking and unlocking each unit in the vehicle.

The still other example of the exclusive equipment system is a case where the first equipment specification is a specification for an internal combustion engine and the second equipment specification is a specification for a hybrid of an internal combustion engine and an electrical motor regarding a travel power system of a vehicle. In this case, the first equipment specification or the second equipment specification may be a specification for an electrical motor. A specification for an electrical motor may be set as a third equipment specification in addition to the first equipment specification and the second equipment specification. Each specification described above is exclusively mounted to a vehicle as a system regarding a travel power of the vehicle.

The still other example of the exclusive equipment system is a case where the first equipment specification is a simple specification and the second equipment specification is a deluxe specification regarding a system of a sound and a video in a vehicle. For example, assumed is a case where the first equipment specification is a specification including only a radio receiver and a speaker and the second equipment specification is a specification including a multimedia player, a display device, a multichannel speaker, and a camera taking an image outside the vehicle.

In the example of the common equipment system and the exclusive equipment system described above, some of the electrical components constituting the common equipment system and some of the electrical components constituting the exclusive equipment system may be used in common in both the systems. Some of the electrical components constituting the first equipment specification and some of the electrical components constituting the second equipment specification set as the exclusive equipment system may be used in common.

The first equipment specification and the second equipment specification may be specifications exclusively selected in manufacturing the vehicle or specifications exclusively selected after manufacturing the vehicle. After one of the first equipment specification and the second equipment specification is selected in manufacturing the vehicle, the specification may be changed to the other one of the first equipment specification and the second equipment specification. For example, the system regarding the sound and the video in the vehicle can be the specification exclusively selected after manufacturing the vehicle, and can be the specification changed from one of the first equipment specification and the second equipment specification to the other one thereof after manufacturing the vehicle.

### <Wiring System>

The wiring system 30 is described with reference to FIG. 1. Circuits 42, 45, 52, 55, 62, 65, and 72 illustrated by one line in FIG. 1 may include a plurality of circuits in some cases.

The wiring system 30 includes a multipurpose wiring member 40, and further exclusively includes a first purpose wiring member 50 and a second purpose wiring member 60. Herein, the exclusive state indicates that when the first purpose wiring member 50 is included, the second purpose wiring member 60 is not included, and when the second purpose wiring member 60 is included, the first purpose wiring member 50 is not included as described above, thus the system 30 as a whole does not deny a possibility of existence of third purpose wiring member or a fourth purpose wiring member, for example.

The multipurpose wiring member 40 includes a multipurpose circuit 42 and a multipurpose connector 46.

The multipurpose circuit 42 is a part made up of a wire-like conductive member to transmit electricity. The multipurpose circuit 42 may be used for transmitting an electrical signal or electrical power. The multipurpose circuit 42 may be a core wire in an electrical wire including the core wire and a covering around the core wire. The electrical wire may be a non-stranded electrical wire or a stranded electrical wire, or may also have a form of a cable around which a shield layer is formed. The multipurpose circuit 42 may not be a core wire in an electrical wire. For example, the multipurpose circuit 42 may be a conductor formed along a predetermined route on a flat insulating base material. For example, the multipurpose circuit may be a circuit pattern in a flexible printed circuit (FPC) in which a circuit pattern of metal foil is formed between a pair of resin films. Description in the present embodiment is based on an assumption that the multipurpose circuit 42 is a core wire in an electrical wire. The description of the multipurpose circuit 42 in the present paragraph can also be adopted to the circuits 42, 43, 44, 45, 52, 55, 62, 65, and 72 described hereinafter, for example, in the similar manner.

The multipurpose circuit 42 is a circuit used for any of the first purpose wiring member 50 and the second purpose wiring member 60. In other words, the multipurpose circuit 42 is a circuit used as a transmission path of electricity in any of the first equipment specification 16 and the second equipment specification 18. That is to say, the multipurpose unit indicates that the unit has a plurality of usage purposes. The multipurpose circuit 42 is also considered a circuit connected to different types of electrical components 16a, 16b, 16c, and 16d or electrical components 18a, 18b, and 18c in accordance with the selected specification.

The multipurpose connector 46 is a connector to which the multipurpose circuit 42 is connected. A first purpose connector 56 or a second purpose connector 66 described hereinafter are exclusively connected to the multipurpose connector 46.

The multipurpose wiring member 40 may include a common circuit 45. The common circuit 45 is a circuit used as a transmission path of the same type of electricity even when any of the first purpose wiring member 50 and the second purpose wiring member 60 is selected. The common circuit 45 is a circuit electrically connected to the electrical components 12a and 12b constituting the common equipment system 12, for example. A larger number of common circuits 45 may be applicable, and the number thereof may be larger than that of circuits regarding the exclusive equipment system 14, for example. The multipurpose wiring member 40 needs not necessarily include the common circuit 45.

The multipurpose wiring member 40 may include a common connector 48. The common connector 48 is a connector used as a connection interface to another wiring member or electrical component even when any of the first purpose wiring member 50 and the second purpose wiring member 60 is selected. For example, the common circuit 45 is assumed to be connected to the common connector 48. The multipurpose wiring member 40 needs not necessarily include the common connector 48.

The first purpose wiring member 50 includes a first purpose circuit 52 and the first purpose connector 56. FIG. 1 illustrates three first purpose wiring members 50.

The first purpose circuit 52 is connected to the first purpose connector 56. The first purpose connector 56 is connected to the multipurpose connector 46, thus the multipurpose circuit 42 is electrically connected to the first purpose circuit 52. The first purpose circuit 52 is electrically connected to the electrical components 16a, 16b, 16c, and 16d in the first equipment specification 16. The first purpose circuit 52 may be connected to the electrical components 16a, 16b, 16c, and 16d via a connector C. It is applicable that the other end portion of the first purpose circuit 52 is directly led to the electrical components 16a, 16b, 16c, and 16d to be connected to electrical elements of the electrical components 16a, 16b, 16c, and 16d without intervention of the connector. The electrical components 16a, 16b, 16c, and 16d are examples of a first electrical component.

The second purpose wiring member 60 includes a second purpose circuit 62 and the second purpose connector 66. FIG. 1 illustrates three second purpose wiring members 60 corresponding to three first purpose wiring members 50 described above. The number of the first purpose wiring members 50 needs not be necessarily the same as that of the second purpose wiring members 60. Assumed in this case is a case where there is no connection destination for the multipurpose connector 46 depending on the specification. The first purpose wiring member 50 and the second purpose wiring member 60 are exclusively assembled to the vehicle 10 in accordance with the selected specification. In other words, the second purpose wiring member 60 is connected to the second electrical component (for example, the electrical components 18a, 18b, and 18c) exclusively mounted with respect to the first electrical component (for example, the electrical components 16a, 16b, 16c, and 16d) in the vehicle 10.

The second purpose circuit 62 is connected to the second purpose connector 66. The second purpose connector 66 is connected to the multipurpose connector 46, thus the multipurpose circuit 42 is electrically connected to the second purpose circuit 62. The second purpose circuit 62 is electrically connected to the electrical components 18a, 18b, and 18c in the second equipment specification 18. The second purpose circuit 62 may be connected to the electrical components 18a, 18b, 18c, and 18d via the connector C. It is applicable that the other end portion of the second purpose circuit 62 is directly led to the electrical components 18a, 18b, and 18c to be connected to electrical elements of the electrical components 18a, 18b, and 18c without intervention of the connector. The electrical components 18a, 18b, 18c, 18d are examples of the second electrical component of a type different from the first electrical component. A state where the type of the first electrical component is different from that of the second electrical component indicates that they can be grasped as different types of components as a result of a fact that specifications to be applied are different from each other, for example. It is also assumed that some of the plurality of first electrical components constituting the first equipment specification and some of the plurality of second electrical components constituting the second equipment specification are the same components.

The first purpose connector 56 and the second purpose connector 66 are connected to the same multipurpose connector 46. Thus, the second purpose connector 66 is assumed to be the same connector as the first purpose connector 56. However, the number of the first purpose circuits 52 is different from that of the second purpose circuits 62, thus it is assumed that the number of the connector terminals of the first purpose connector 56 and the second purpose connector 66 are different from each other or at least one of the first purpose connector 56 and/or the second purpose connector 66 includes a dummy connector terminal which is not connected to the electrical wire.

When the plurality of electrical components are connection destinations of the multipurpose connector 46, the plurality of first purpose circuits 52 or the plurality of second purpose circuits 62 may be branched in a midway portion in the first purpose wiring member 50 or the second purpose wiring member 60. In FIG. 1, the plurality of first purpose circuits 52 are branched in a midway portion in accordance with the electrical components 16b and 16c in the first equipment specification 16.

Each of the first purpose wiring member 50 and the second purpose wiring member 60 may include terminal side common circuits 55 and 65 for the electrical components 12a and 12b in the common equipment system 12. FIG. 1 illustrates an example that the first purpose wiring member 50 includes the terminal side common circuit 55 and the second purpose wiring member 60 includes the terminal side common circuit 65 to correspond to the electrical component 12a. The terminal side common circuit 55 is connected to the first purpose connector 56, and the terminal side common circuit 65 is connected to the second purpose connector 66. When the first purpose wiring member 50 is selected, the common circuit 45 in the multipurpose wiring member 40 is connected to the electrical component 12a via the terminal side common circuit 55. When the second purpose wiring member 60 is selected, the common circuit 45 in the multipurpose wiring member 40 is connected to the electrical component 12a via the terminal side common circuit 65. That is to say, the terminal side common circuits 55 and 65 are circuits connected to the same type of electrical component regardless of the specification.

In FIG. 1, a terminal side common wiring member 70 is connected to the common connector 48. The terminal side common wiring member 70 includes a circuit 72 and a connector 76. One end portion of the circuit 72 is connected to the connector 76, and the other end portion of the circuit 72 is connected to the electrical component 12b in the common equipment system via the connector C or without intervention of the connector. The connector 76 is connected to the common connector 48, thus the common circuit 45 in the multipurpose wiring member 40 is connected to the electrical component 12b via the circuit 72. That is to say, the terminal side common wiring member 70 is a wiring member which does not include the first purpose circuit 52 and the second purpose circuit 62 but is connected to the same type of electrical component regardless of the specification.

### <Example of Wiring System>

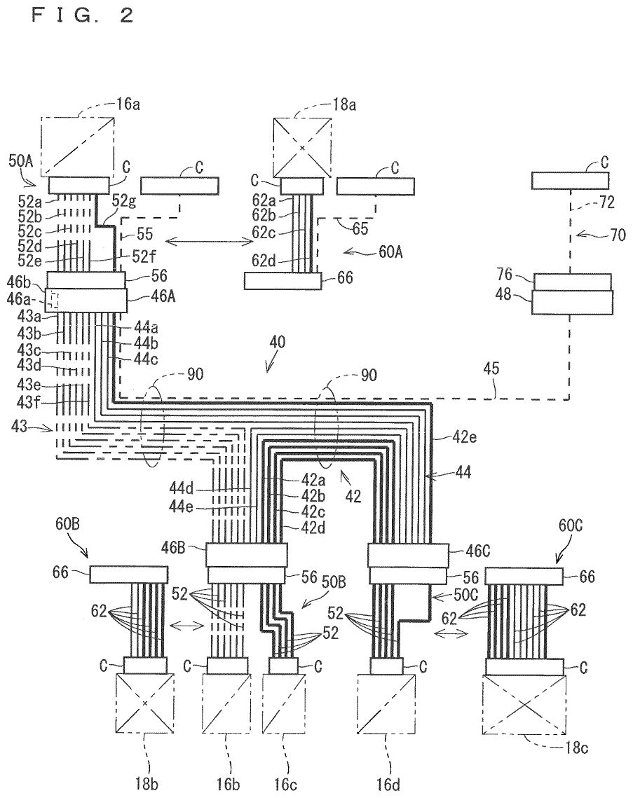

One specific example of the wiring system 30 is described with reference to FIG. 2 based on a premise of the wiring system 30 described in FIG. 1. The circuit and the connector, for example, are distinguished and described in FIG. 2, however, the number of the circuits, the route of the circuit, and the number of the connectors are examples, thus can be changed in accordance with a system and specification to be applied. Each circuit is distinguished by a solid line, a thick line, a dotted line, and a dash-double-dot line, for example, in FIG. 2 for convenience of description.

The multipurpose wiring member 40 includes at least one (for example, five) multipurpose circuit 42. The plurality of multipurpose circuits 42 are distinguished into the multipurpose circuits 42a, 42b, 42c, 42d, and 42e hereinafter as necessary.

The multipurpose wiring member 40 includes at least one (for example, six) main wire-side first purpose circuit 43. The plurality of main wire-side first purpose circuits 43 are distinguished into main wire-side first purpose circuits 43a, 43b, 43c, 43d, 43e, and 43f hereinafter as necessary.

The multipurpose wiring member 40 includes at least one (for example, five) main wire-side second purpose circuit 44. The plurality of main wire-side second purpose circuits 44 are distinguished into main wire-side second purpose circuits 44a, 44b, 44c, 44d, and 44e hereinafter as necessary.

The multipurpose connector 46 in the multipurpose wiring member 40 is distinguished into the multipurpose connectors 46A, 46B, and 46C in accordance with a connection destination. The multipurpose connectors 46A, 46B, and 46C and the common connector 48 include a plurality of connector terminals 46a (some of them are illustrated in FIG. 2) and a connector housing 46b, for example. Each end portion of the multipurpose circuit 42, the main wire-side first purpose circuit 43, and the main wire-side second purpose circuit 44 is connected to any connector terminal 46a in the multipurpose connectors 46A, 46B, and 46C and the common connector 48.

Herein, one ends of the multipurpose circuits 42a, 42b, 42c, and 42d are connected to the connector terminal in the multipurpose connector 46B, and the other ends thereof are connected to the connector terminal in the multipurpose connector 46C. One end of the multipurpose circuit 42e is connected to the connector terminal in the multipurpose connector 46A, and the other end thereof is connected to the connector terminal in the multipurpose connector 46C.

One ends of the main wire-side first purpose circuits 43a, 43b, 43c, 43d, 43e, and 43f are connected to the connector terminal in the multipurpose connector 46A, and the other ends thereof are connected to the connector terminal in the multipurpose connector 46B.

One ends of the main wire-side second purpose circuits 44a, 44b, and 44c are connected to the connector terminal in the multipurpose connector 46A, and the other ends thereof are connected to the connector terminal in the multipurpose connector 46C. One ends of the main wire-side second purpose circuits 44d and 44e are connected to the connector terminal in the multipurpose connector 46B, and the other ends thereof are connected to the connector terminal in the multipurpose connector 46C.

One end of the common circuit 45 is connected to the connector terminal in the multipurpose connector 46A, and the other end thereof is connected to the connector terminal in the common connector 48. When the plurality of circuits described above pass through the same route, the plurality of circuits may be kept in a bundled state by a banding member 90 such as an adhesive tape or a banding band, for example.

In the example of this multipurpose wiring member 40, a total number of the circuits is seventeen, and a total number of the circuits for the exclusive equipment system 14 except for the common circuit 45 is sixteen. The number of the circuits of the multipurpose circuit 42 is five. Thus, a ratio of the number of the multipurpose circuits 42 to all of the number of the circuits, that is seventeen, in the multipurpose wiring member 40 is approximately 29.41%. A ratio of the number of the multipurpose circuits 42 to the total number of the circuits, that is sixteen, for the exclusive equipment system 14 is 31.25%.

The plurality of first purpose wiring members 50 are distinguished into the first purpose wiring members 50A, 50B, and 50C. The first purpose wiring member 50A is connected to the multipurpose connector 46A, the first purpose wiring member 50B is connected to the multipurpose connector 46B, and the first purpose wiring member 50C is connected to the multipurpose connector 46C. Focusing on the first equipment specification 16, the first purpose wiring member 50A is connected to the electrical component 16a, the first purpose wiring member 50B is connected to the electrical components 16b and 16c, and the first purpose wiring member 50C is connected to the electrical component 16d.

The first purpose wiring member 50A includes at least one (for example, seven) first purpose circuit 52 and the terminal side common circuit 55. The plurality of first purpose circuits 52 are distinguished into the first purpose circuits 52a, 52b, 52c, 52d, 52e, 52f, and 52g.

When the first purpose connector 56 is connected to the multipurpose connector 46A, the first purpose circuits 52a, 52b, 52c, 52d, 52e, and 52f are electrically connected to the main wire-side first purpose circuits 43a, 43b, 43c, 43d, 43e, and 43f, and the first purpose circuit 52g is connected to the multipurpose circuit 42e. Thus, the main wire-side first purpose circuits 43a, 43b, 43c, 43d, 43e, and 43f and the multipurpose circuit 42e are electrically connected to the electrical component 16a via the first purpose circuits 52a, 52b, 52c, 52d, 52e, 52f, and 52g.

The common circuit 45 is electrically connected to the electrical component 12a via the terminal side common circuit 55. The main wire-side second purpose circuits 44a, 44b, and 44c are open circuits on a side of the multipurpose connector 46A.

The first purpose wiring member 50B includes at least one (for example, ten) first purpose circuit 52. The plurality of first purpose circuits 52 are branched in a midway portion away from the first purpose connector 56 to be connected to the electrical components 16b and 16c. When the first purpose connector 56 is connected to the multipurpose connector 46B, the first purpose circuit 52 is connected to the main wire-side first purpose circuits 43a, 43b, 43c, 43d, 43e, and 43f and the multipurpose circuits 42a, 42b, 42c, and 42d. Thus, the main wire-side first purpose circuits 43a, 43b, 43c, 43d, 43e, and 43f and the multipurpose circuits 42a, 42b, 42c, and 42d are electrically connected to the electrical component 16b or 16c via the first purpose circuit 52 of the first purpose wiring member 50B. In this case, the main wire-side second purpose circuits 44d and 44e are in an open state in the multipurpose connector 46B.

The first purpose wiring member 50C includes at least one (for example, five) first purpose circuit 52. When the first purpose connector 56 is connected to the multipurpose connector 46C, the first purpose circuit 52 is connected to the multipurpose circuits 42a, 42b, 42c, 42d, and 42e. Thus, the multipurpose circuits 42a, 42b, 42c, 42d, and 42e are electrically connected to the electrical component 16d via the first purpose circuit 52 of the first purpose wiring member 50C. In this case, the main wire-side second purpose circuits 44a, 44b, 44c, 44d, and 44e are in an open state in the multipurpose connector 46C.

The plurality of second purpose wiring members 60 are distinguished into the second purpose wiring members 60A, 60B, and 60C in the manner similar to the above description.

The second purpose wiring member 60A includes at least one (for example, three) second purpose circuit 62 and the terminal side common circuit 65. The plurality of second purpose circuits 62 are distinguished into the second purpose circuits 62a, 62b, 62c, and 62d.

When the second purpose connector 66 is connected to the multipurpose connector 46A, the second purpose circuits 62a, 62b, and 62c are electrically connected to the main wire-side second purpose circuits 44a, 44b, and 44c, and the second purpose circuit 62d is connected to the multipurpose circuit 42e. Thus, the main wire-side second purpose circuits 44a, 44b, and 44c and the multipurpose circuit 42e are electrically connected to the electrical component 18a via the second purpose circuits 62a, 62b, 62c, and 62d.

In the manner similar to the case of selecting the first purpose wiring member 50A, the common circuit 45 is electrically connected to the electrical component 12a via the terminal side common circuit 65. Differing from the case of selecting the first purpose wiring member 50A, the main wire-side first purpose circuits 43a, 43b, 43c, 43d, 43e, and 43f are in an open state in a side of the multipurpose connector 46A.

The second purpose wiring member 60B includes at least one (for example, six) second purpose circuit 62. When the second purpose connector 66 is connected to the multipurpose connector 46B, the second purpose circuit 62 is connected to the main wire-side second purpose circuits 44d and 44e and the multipurpose circuits 42a, 42b, 42c, and 42d. Thus, the main wire-side second purpose circuits 44d and 44e and the multipurpose circuits 42a, 42b, 42c, and 42d are electrically connected to the electrical component 18b via the second purpose circuits 62 of the second purpose wiring member 60B. In this case, the main wire-side first purpose circuits 43a, 43b, 43c, 43d, 43e, and 43f are in an open state in the multipurpose connector 46B.

The second purpose wiring member 60C includes at least one (for example, ten) second purpose circuit 62. When the second purpose connector 66 is connected to the multipurpose connector 46C, the second purpose circuit 62 is connected to the multipurpose circuits 42a, 42b, 42c, 42d, and 42e and the main wire-side second purpose circuits 44a, 44b, 44c, 44d, and 44e. Thus, the multipurpose circuits 42a, 42b, 42c, 42d, and 42e and the main wire-side second purpose circuits 44a, 44b, 44c, 44d, and 44e are electrically connected to the electrical component 18c via the second purpose circuit 62 of the second purpose wiring member 60C.

When the wiring system 30 is applied to the first equipment specification 16, the first purpose wiring members 50A, 50B, and 50C are selected. In this case, the multipurpose circuit 42 and the main wire-side first purpose circuit 43 in the multipurpose wiring member 40 are used, and the main wire-side second purpose circuit 44 is not used while being in the open state in each connector.

When the wiring system 30 is applied to the second equipment specification 18, the second purpose wiring members 60A, 60B, and 60C are selected. In this case, the multipurpose circuit 42 and the main wire-side second purpose circuit 44 in the multipurpose wiring member 40 are used, and the main wire-side first purpose circuit 43 is not used while being in the open state in each connector.

In any case, the multipurpose circuit 42 is used. That is to say, the multipurpose circuit is used as a circuit for the plurality of specifications. The multipurpose circuit is used as the multipurpose circuit in common between the plurality of specifications, thus the number of the circuits can be reduced as the wiring member for the plurality of specifications.

### <Example for Comparison>

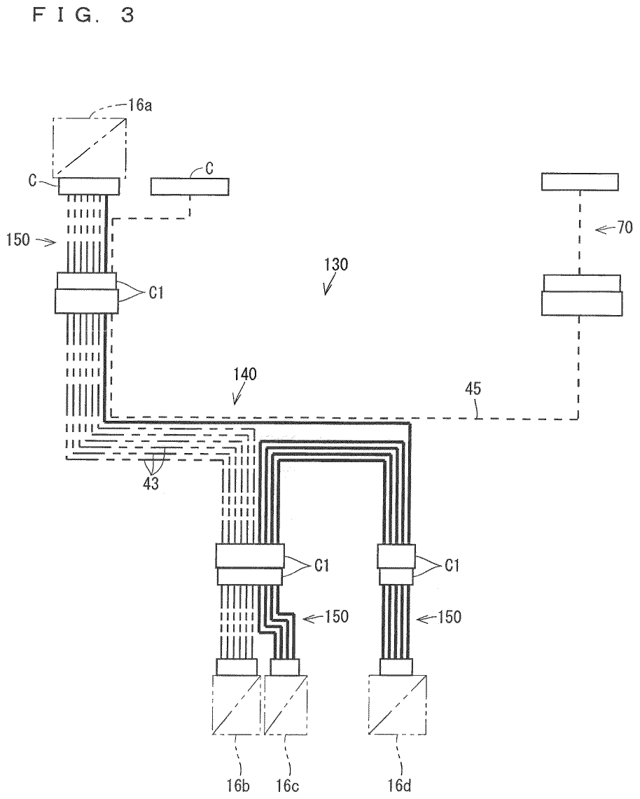

A case where the multipurpose circuit is not used is assumed for comparison. FIG. 3 illustrates a wiring system 130 dedicated to the first equipment specification 16 as a first example. In this case, a main wire wiring member 140 is assumed to have a configuration that the main wire-side second purpose circuit 44 is omitted in the multipurpose wiring member 40 in the wiring system 30 described above. In a connector of the main wire wiring member 140 and a first purpose wiring member 150 corresponding to the first purpose wiring member 50, a connector C1 with a size including connector terminals whose number corresponds to the number of the reduced circuits is assumed to be used. A total number of the circuits of the present main wire wiring member 140 is twelve, and a total number of the circuits according to the exclusive equipment system is eleven.

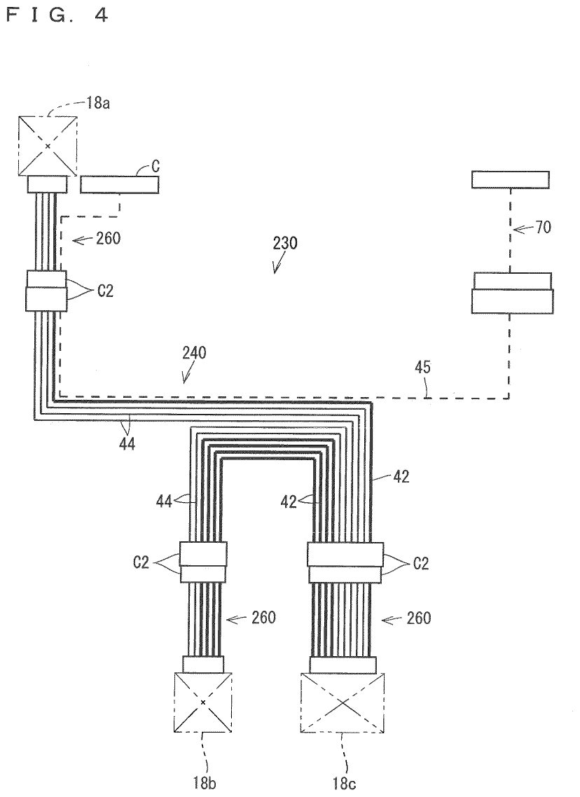

FIG. 4 illustrates a wiring system 230 dedicated to the second equipment specification 18 as a second example. In this case, a main wire wiring member 240 is assumed to have a configuration that the main wire-side first purpose circuit 43 is omitted in the multipurpose wiring member 40 in the wiring system 30 described above. In a connector of the main wire wiring member 240 and a second purpose wiring member 260 corresponding to the second purpose wiring member 60, a connector C2 with a size including connector terminals whose number corresponds to the number of the reduced circuits is assumed to be used. A total number of the circuits of the present main wire wiring member 240 is eleven, and a total number of the circuits according to the exclusive equipment system is ten.

When the main wire wiring members 140 and 240 are separately prepared in the first equipment specification 16 and the second equipment specification 18, a management part number of the wiring member and a stock thereof to be managed increase. In order to deal with both specifications of the first equipment specification 16 and the second equipment specification 18, when the main wire wiring members 140 and 240 are simply integrated with each other, the number of the circuits increases too much. For example, when the main wire wiring members 140 and 240 are simply integrated with each other, the number of the circuits becomes twenty-two by subtracting the number of the circuits for the common circuit 45 from a simple sum of the total number of the circuits. The total number of the circuits after integration is twenty-one in consideration of only the circuit according to the exclusive equipment system.

In the meanwhile, the multipurpose circuit 42 is used for both the first equipment specification 16 and the second equipment specification 18 in the present wiring system 30. A difference of a length, route, connection configuration of the circuit caused by a difference of types of the electrical components 16a, 16b, 16c, and 16d of the first equipment specification 16 and the electrical components 16a, 16b, and 16c of the second equipment specification 18 is resolved by the first purpose wiring member 50 or the second purpose wiring member 60. The number of the circuits can be reduced by reason that the multipurpose circuit 42 is used. In the example illustrated in FIG. 2, the multipurpose wiring member 40 includes five multipurpose circuits 42, thus five circuits are reduced compared with the case where the main wire wiring members 140 and 240 are simply integrated with each other.

As a ratio of the number of the multipurpose circuits 42 to the total number of the circuits in the multipurpose wiring member 40 gets larger, the effect of reducing the number of the circuits increases. For example, a ratio of the number of the multipurpose circuits to all of the number of circuits in the multipurpose wiring member 40 may be equal to or larger than 10%. The ratio of the number of the multipurpose circuits to the total number of the circuits in the multipurpose wiring member 40 is preferably equal to or larger 15%, more preferably equal to or larger than 20%, further more preferably equal to or larger than 25%, and still further more preferably equal to or larger than 30%.

In the similar manner, the ratio of the number of the multipurpose circuits 42 to the total number of circuits for the exclusive equipment system 14 in the multipurpose wiring member 40 may also be equal to or larger than 10%, preferably equal to or larger 15%, more preferably equal to or larger than 20%, further more preferably equal to or larger than 25%, and still further more preferably equal to or larger than 30%.

### <Example of Connection Destination of Multipurpose Circuit>

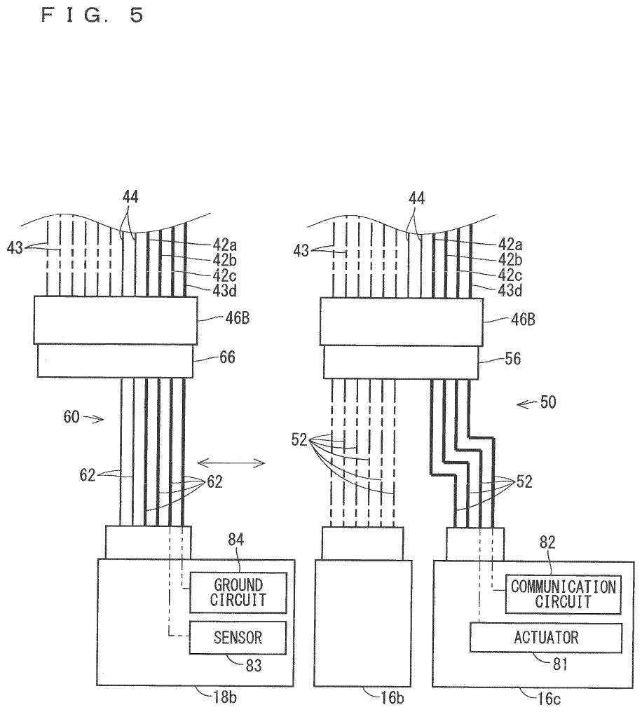

FIG. 5 is an explanation view illustrating an example of a connection destination of the multipurpose circuit 42. FIG. 5 illustrates an example of the multipurpose circuits 42a, 42b, 42c, and 42d connected to the electrical component 16c via the first purpose wiring member 50 and an example thereof connected to the electrical component 18b via the second purpose wiring member 60.

As illustrated in FIG. 5, the multipurpose circuit 42 includes the circuits 42c and 42d transmitting different types of electricity between a state where the first purpose connector 56 is connected to the multipurpose connector 46B and a state where the second purpose connector 66 is connected to the multipurpose connector 46B.

The circuit transmitting the different types of electricity is a circuit in which voltage to be applied, a maximum current value to be assumed, or a signal form is different between the first equipment specification 16 and the second equipment specification 18, for example.

The multipurpose connector 46 may include the circuits 42c and 42d transmitting different types of electricity for any of a power source, a ground, and a signal between a state where the first purpose connector 56 is connected to the multipurpose connector 46B and a state where the second purpose connector 66 is connected to the multipurpose connector 46B.

In the example illustrated in FIG. 5, when the first purpose connector 56 of the first purpose wiring member 50 is connected to the multipurpose connector 46B, the multipurpose circuit 42c is connected to an actuator 81 to serve as a circuit for supplying a power source electricity of the actuator 81. In the meanwhile, when the second purpose connector 66 of the second purpose wiring member 60 is connected to the multipurpose connector 46B, the multipurpose circuit 42c is connected to a sensor 83 to serve as a circuit for transmitting a detection signal.

When the first purpose connector 56 of the first purpose wiring member 50 is connected to the multipurpose connector 46B, the multipurpose circuit 42d is connected to a communication circuit 82 to serve as a circuit for transmitting a communication signal. In the meanwhile, when the second purpose connector 66 of the second purpose wiring member 60 is connected to the multipurpose connector 46B, the multipurpose circuit 42d is connected to a ground circuit 84 to serve as a circuit transmitting electricity for a ground.

A size of a cross section of the multipurpose circuit 42 is not particularly limited. For example, when the multipurpose circuit 42 is a core wire of an electrical wire, a cross-sectional area of the core wire may be classified into any of 0.13 sq, 0.35 sq, 0.5 sq, and 2 sq. A unit sq is a standard regarding a cross-sectional area of a core wire regulated by JIS standard, and indicates square millimeter. The multipurpose circuit 42 can be used for transmitting each type of electricity within a range of current allowed in accordance with a cross-sectional area and material of the circuit, for example.

### <Effect etc.>

According to the wiring system 30 and the multipurpose wiring member 40 having the above configurations, when the first purpose connector 56 is connected to the multipurpose connector 46, the multipurpose circuit 42 is used for connection to the first electrical component (for example, the electrical components 16a, 16b, 16c, and 16d). When the second purpose connector 66 is connected to the multipurpose connector 46, the multipurpose circuit 42 is used for connection to the second electrical component (for example, the electrical components 18a, 18b, and 18c). Thus, the multipurpose wiring member 40 can be used for both the first equipment specification 16 including the first electrical component and the second equipment specification 18 including the second electrical component while using the multipurpose circuit 42 for wiring to the first electrical component or the second electrical component and reducing a management part number. Accordingly, it is possible to easily deal with the equipment specifications 16 and 18 of the plurality of vehicles while the number of circuits is reduced.

The first electrical component (for example, the electrical components 16a, 16b, 16c, and 16d) and the second electrical component (for example, the electrical components 18a, 18b, and 18c) are exclusively mounted to the vehicle. Thus, the circuit for the first electrical component and the circuit for the second electrical component need not be incorporated at the same time in the multipurpose wiring member 40. In this manner, the circuit for the first electrical component and the circuit for the second electrical component which need not be provided separately can be used as the multipurpose circuit 42.

When the ratio of the number of at least one multipurpose circuit 42 to the number of all of the circuits in the multipurpose wiring member 40 is equal to or larger than 10%, the number of the circuits in the multipurpose wiring member 40 can be effectively reduced.

The multipurpose circuit 42 is used as the circuit transmitting the different type of electricity, thus the number of the circuits in the multipurpose wiring member 40 can be effectively reduced regardless of a transmission type of electricity.

For example, when the multipurpose circuit is used as the circuit transmitting the different types of electricity for any of a power source, a ground, and a signal, thus the circuit can be used for multiple purposes without distinguishing the circuit for a power source, a ground, and a signal, and the number of circuits in the multipurpose wiring member 40 can be effectively reduced.

### <Modification Example According to Embodiment 1>

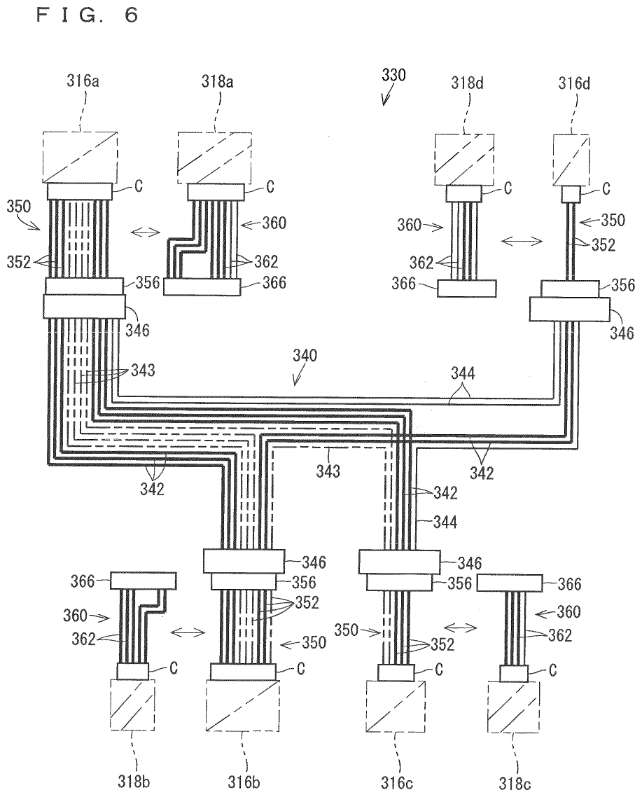

FIG. 6 illustrates a wiring system 330 according to a modification example of the embodiment 1. Assumed in the present modification example is a case where the first equipment specification is a mechanical key specification and the second equipment specification is a smart key specification. Assumed as first electrical components 316a, 316b, 316c, and 316d for the first equipment specification are a door lock unit detecting a state of a cylinder lock incorporated into a door, an indoor lock unit detecting a state of a cylinder lock incorporated into an area around a handle, various actuators performing handle lock and door lock, for example, and an ECU controlling various lock state in a vehicle, for example. Assumed as second electrical components 318a, 318b, 318c, and 318d for the second equipment specification are a communication circuit performing wireless communication with a wireless key terminal owned by a driver, various actuators performing handle lock and door lock, for example, and an ECU performing an authentication operation based on output from a communication circuit and controlling various lock state in a vehicle, for example.

A wiring system 330 includes a multipurpose wiring member 340 corresponding to the multipurpose wiring member 40 described above, and exclusively includes a first purpose wiring member 350 corresponding to the first purpose wiring member 50 and a second purpose wiring member 360 corresponding to the second purpose wiring member 60.

In the present modification example, four first purpose wiring members 350 and four second purpose wiring members 360 are exclusively selected in accordance with the specification. Thus, a multipurpose circuit 342 corresponding to the multipurpose circuit 42, a main wire-side first purpose circuit 343 corresponding to the main wire-side first purpose circuit 43, and a main wire-side second purpose circuit 344 corresponding to the main wire-side second purpose circuit 44 in the multipurpose wiring member 340 are branched to four multipurpose connectors 346 corresponding to the multipurpose connector 46 and are connected thereto.

The first purpose wiring member 350 includes a first purpose circuit 352 corresponding to the first purpose circuit 52 and a first purpose connector 356 corresponding to the first purpose connector 56. The second purpose wiring member 360 includes a second purpose circuit 362 corresponding to the second purpose circuit 62 and a second purpose connector 366 corresponding to the second purpose connector 66.

In the manner similar to the description in the embodiment 1, when the first equipment specification is selected, the first purpose connector 356 of the first purpose wiring member 350 is connected to the multipurpose connector 346. Accordingly, the multipurpose circuit 342 and the main wire-side first purpose circuit 343 in the multipurpose wiring member 340 are electrically connected to the first electrical components 316a, 316b, 316c, and 316d via the first purpose circuit 352. At this time, the main wire-side second purpose circuit 344 is kept in an open state in the multipurpose connector 346.

When the second equipment specification is selected, the second purpose connector 366 of the second purpose wiring member 360 is connected to the multipurpose connector 346. Accordingly, the multipurpose circuit 342 and the main wire-side second purpose circuit 344 in the multipurpose wiring member 340 are electrically connected to the second electrical components 318a, 318b, 318c, and 318d via the second purpose circuit 362. At this time, main wire-side first purpose circuit 343 is kept in an open state in the multipurpose connector 346.

Also according to the present modification example, the function effect similar to that in the embodiment 1 described above can be obtained.

### Embodiment 2

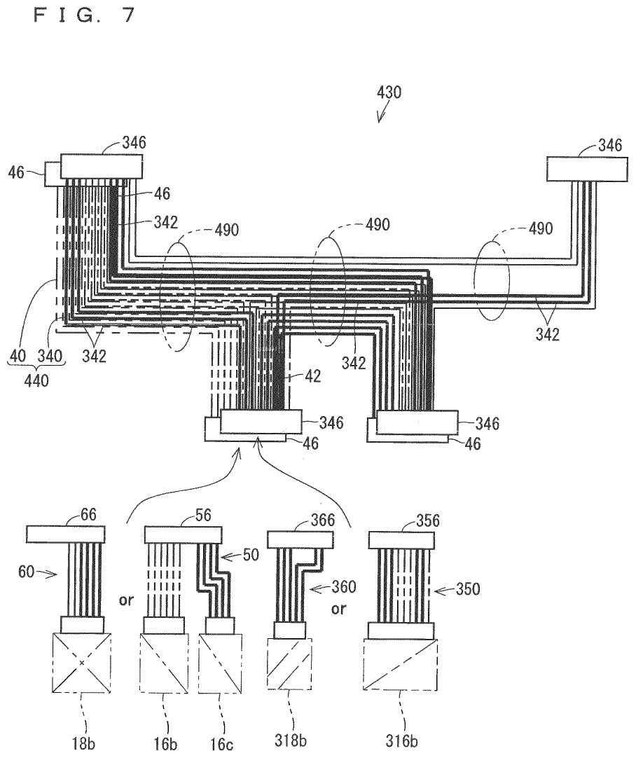

A wiring system according to an embodiment 2 is described. In the description of the present embodiment, the same reference numerals are assigned to the similar constituent elements described in the embodiment 1 and the modification example thereof, and the description thereof will be omitted. FIG. 7 is an explanation view illustrating a wiring system 430 according to the embodiment 2.

The present wiring system 430 is a system based on an assumption that a plurality of exclusive equipment systems in which the first equipment specification and the second equipment specification are exclusively adopted are set. Assumed in the description of the present embodiment is a case of setting the exclusive equipment system regarding the drive transmission system in which the first equipment specification 16 is the AT specification and the second equipment specification 18 is the MT specification as described in the embodiment 1 and the exclusive equipment system regarding the key system in which the first equipment specification is the mechanical key specification and the second equipment specification is the smart key specification as described in the modification example.

In the present embodiment, the wiring system 430 includes a multipurpose wiring member 440. The multipurpose wiring member 440 has a configuration that the multipurpose wiring member 40 according to the embodiment 1 and the multipurpose wiring member 340 according to the modification example are integrated with each other. The multipurpose wiring member 440 includes the multipurpose circuit 42 corresponding to the exclusive equipment system regarding the drive transmission system and the multipurpose circuit 342 corresponding to the exclusive equipment system regarding the key system as the multipurpose circuits 42 and 342.

The multipurpose wiring member 40 and the multipurpose wiring member 340 may be bundled by a banding member 490 by an adhesive tape or a banding band, for example, to be integrated with each other. The circuit of the multipurpose wiring member 40 and the circuit of the multipurpose wiring member 340 may be mixedly bundled with each other.

The wiring system 430 exclusively includes the first purpose wiring member 50 and the second purpose wiring member 60 corresponding to the exclusive equipment system regarding the drive transmission system (partially illustrated in FIG. 7). The wiring system 430 exclusively includes the first purpose wiring member 350 and the second purpose wiring member 360 corresponding to the exclusive equipment system regarding the key system (partially illustrated in FIG. 7).

The first purpose wiring member 50 and the second purpose wiring member 60 are exclusively selected in accordance with the selection of the specification of the exclusive equipment system regarding the drive transmission mechanism, thus as described in the embodiment 1 described above, the multipurpose circuit 42 is exclusively connected to the electrical components 16a, 16b, 16c, and 16d or the electrical components 18a, 18b, and 18c in accordance with the selection.

The first purpose wiring member 350 and the second purpose wiring member 360 are exclusively selected in accordance with the selection of the specification of the exclusive equipment system regarding the key system, thus as described in the modification example described above, the multipurpose circuit 342 is exclusively connected to the electrical components 316a, 316b, 316c, and 316d or the electrical components 318a, 318b, 318c, and 318d in accordance with the selection.

According to the present wiring system 430, the function effect similar to that in the embodiment 1 described above can be obtained. In addition, when the plurality of exclusive equipment systems are provided, the multipurpose circuits 42 and 342 can be used for the first equipment specification and the second equipment specification in common in at least two of the plurality of exclusive equipment systems. Accordingly, the multipurpose wiring member 440 can deal with various combinations of the plurality of exclusive equipment systems, and such a configuration contributes to reduction in the number of part numbers of the multipurpose wiring member 440.

When the plurality of exclusive equipment systems are set in the vehicle, the multipurpose circuit needs not be set for all of the exclusive equipment systems. It is assumed in this case that the part number is applied in common by the specification of the multipurpose circuit described above in some exclusive equipment systems, and the multipurpose wiring members are prepared for each specification in the other some exclusive equipment systems.

### [Appendix]

A manufacturing method through the following process can be adopted in manufacturing the wiring system described above.

Prepared are: a multipurpose wiring member including a multipurpose circuit and a multipurpose connector to which the multipurpose circuit is connected; a first purpose wiring member including a first purpose circuit and a first purpose connector to which the first purpose circuit is connected, the first purpose wiring member electrically connecting the first purpose circuit to a first electrical component; and a second purpose wiring member including a second purpose circuit and a second purpose connector to which the second purpose circuit is connected, the second purpose wiring member electrically connecting the second purpose circuit to a second electrical component of a type different from the first electrical component. When the multipurpose circuit is electrically connected to the first electrical component, the first purpose wiring member is selected, the first purpose connector is connected to the multipurpose connector. When the multipurpose circuit is electrically connected to the second electrical component, the second purpose wiring member is selected, the second purpose connector is connected to the multipurpose connector, and the multipurpose circuit is electrically connected to the second electrical component via the second purpose circuit.

Each configuration described in the above embodiments and modification examples thereof can be appropriately combined as long as they are not contradictory.

### EXPLANATION OF REFERENCE SIGNS

10 vehicle
12 common equipment system
12a, 12b electrical component
14 exclusive equipment system
16 first equipment specification
16a, 16b, 16c, 16d, 316a, 316b, 316c, 316d first electrical component
18 second equipment specification
18a, 18b, 18c, 318a, 318b, 318c, 318d second electrical component
30, 130, 230, 330, 430 wiring system
40, 340, 440 multipurpose wiring member
42 (42a, 42b, 42c, 42d, 42e), 342 multipurpose circuit
43 (43a, 43b, 43c, 43d, 43e, 43f), 343 main wire-side first purpose circuit
44 (44a, 44b, 44c, 44d, 44e), 344 main wire-side second purpose circuit
45 common circuit
46 (46A, 46B, 46C), 346 multipurpose connector
46a connector terminal
46b connector housing
48 common connector
50 (50A, 50B, 50C), 150, 350 first purpose wiring member
52 (52a, 52b, 52c, 52d, 52e, 52f, 52g), 352 first purpose circuit
55 terminal side common circuit
56, 356 first purpose connector
60 (60A, 60B, 60C), 260, 360 second purpose wiring member
62 (62a, 62b, 62c, 62d), 362 second purpose circuit
65 terminal side common circuit
66, 366 second purpose connector
70 terminal side common wiring member
72 circuit
76 connector
81 actuator
82 communication circuit
83 sensor
84 ground circuit
90, 490 banding member
140, 240 main wire wiring member
C, C1, C2 connector

1. A wiring system, comprising
a multipurpose wiring member including at least one multipurpose circuit and a multipurpose connector to which the multipurpose circuit is connected, the wiring system further exclusively including:
a first purpose wiring member including a first purpose circuit and a first purpose connector to which the first purpose circuit is connected, the first purpose wiring member electrically connecting the first purpose circuit to a first electrical component; and
a second purpose wiring member including a second purpose circuit and a second purpose connector to which the second purpose circuit is connected, the second purpose wiring member electrically connecting the second purpose circuit to a second electrical component of a type different from the first electrical component, wherein
the multipurpose circuit is a core wire of an electrical wire,
the multipurpose connector includes a connector terminal connected to an end portion of the core wire, and
when the first purpose connector is connected to the multipurpose connector, the multipurpose circuit is connected to the first purpose circuit, and when the second purpose connector is connected to the multipurpose connector, the multipurpose circuit is connected to the second purpose circuit.

2. The wiring system according to claim 1, wherein
the second purpose wiring member is connected to the second electrical component exclusively mounted to the first electrical component in a vehicle.

3. The wiring system according to claim 1, wherein
when a plurality of exclusive equipment systems in which a first equipment specification including the first electrical component and a second equipment specification including the second electrical component are exclusively adopted are set,
the multipurpose circuit includes circuits exclusively connected to the first electrical component and the second electrical component to correspond to at least two of the plurality of exclusive equipment systems, respectively.

4. The wiring system according to claim 1, wherein
the multipurpose wiring member includes a plurality of circuits including at least one of the multipurpose circuits, and
a ratio of a total number of the at least one of the multipurpose circuits to a total number of all of the plurality of circuits in the multipurpose wiring member is equal to or larger than 10%.

5. The wiring system according to claim 1, wherein
the multipurpose circuit includes a circuit transmitting a different type of electricity between a state where the first purpose connector is connected to the multipurpose connector and a state where the second purpose connector is connected to the multipurpose connector.

6. The wiring system according to claim 1, wherein
the multipurpose circuit includes a circuit transmitting a different type of electricity for any of a power source, a ground, and a signal between a state where the first purpose connector is connected to the multipurpose connector and a state where the second purpose connector is connected to the multipurpose connector.

7. A multipurpose wiring member, comprising a multipurpose circuit connected to a different type of electrical component, and a multipurpose connector to which the multipurpose circuit is connected, wherein
the multipurpose circuit is a core wire of an electrical wire, and
the multipurpose connector includes a connector terminal connected to an end portion of the core wire.

8. The wiring system according to claim 3, wherein
the plurality of exclusive equipment systems include at least one system in a system in which an AT specification and an MT specification are exclusively adopted, a system in which a mechanical key specification and a smart key specification are exclusively adopted, a system in which a specification for an internal combustion engine and a specification for a hybrid are exclusively adopted, a system in which a specification for an internal combustion engine and a specification for an electrical motor are exclusively adopted, and a system in which a specification for an electrical motor and a specification for a hybrid are exclusively adopted.

9. The wiring system according to claim 1, wherein
the first purpose circuit is a core wire of an electrical wire,
the first purpose connector includes a connector terminal connected to an end portion of the core wire as the first purpose circuit,
the second purpose circuit is a core wire of an electrical wire, and
the second purpose connector includes a connector terminal connected to an end portion of the core wire as the second purpose circuit.

10. A wiring system, comprising
a multipurpose wiring member including at least one multipurpose circuit and a multipurpose connector to which the multipurpose circuit is connected, the wiring system further exclusively including:
a first purpose wiring member including a first purpose circuit and a first purpose connector to which the first purpose circuit is connected, the first purpose wiring member electrically connecting the first purpose circuit to a first electrical component; and
a second purpose wiring member including a second purpose circuit and a second purpose connector to which the second purpose circuit is connected, the second purpose wiring member electrically connecting the second purpose circuit to a second electrical component of a type different from the first electrical component, wherein
the multipurpose wiring member further includes a main wire-side first purpose circuit and a main wire-side second purpose circuit, and
when the first purpose connector is connected to the multipurpose connector, the first purpose circuit is connected to the multipurpose circuit or the main wire-side first purpose circuit and the main wire-side second purpose circuit is in an open state, and when the second purpose connector is connected to the multipurpose connector, the second purpose circuit is connected to the multipurpose circuit or the main wire-side second purpose circuit and the main wire-side first purpose circuit is in an open state.

11. A wiring system, comprising
a multipurpose wiring member including at least one multipurpose circuit and a multipurpose connector to which the multipurpose circuit is connected, the wiring system further exclusively including:
a first purpose wiring member including a first purpose circuit and a first purpose connector to which the first purpose circuit is connected, the first purpose wiring member electrically connecting the first purpose circuit to a first electrical component; and
a second purpose wiring member including a second purpose circuit and a second purpose connector to which the second purpose circuit is connected, the second purpose wiring member electrically connecting the second purpose circuit to a second electrical component of a type different from the first electrical component, wherein
when the first purpose connector is connected to the multipurpose connector, the multipurpose circuit is connected to the first purpose circuit, and when the second purpose connector is connected to the multipurpose connector, the multipurpose circuit is connected to the second purpose circuit,
the multipurpose wiring member includes a common circuit,
each of the first purpose wiring member and the second purpose wiring member includes a terminal side common circuit, and
when one of the first purpose connector and the second purpose connector is connected to the multipurpose connector, the common circuit is connected to the terminal side common circuit, and the terminal side common circuit is connected to an electrical component which is a connection destination different from a connection destination for the first purpose circuit and the second purpose circuit.
